(19) United States
(12) Patent Application Publication
(10) Pub. No.: US 2025/0078358 A1
(43) Pub. Date: Mar. 6, 2025

(54) Automatically Generating and Enhancing Personalized Digital Illustrations

(71) Applicant: Google LLC, Mountain View, CA (US)

(72) Inventors: Leonard Guangyong Chan, Singapore (SG); Yohan Jonathan Launay, Singapore (SG)

(21) Appl. No.: 18/807,288

(22) Filed: Aug. 16, 2024

Related U.S. Application Data
(60) Provisional application No. 63/535,356, filed on Aug. 30, 2023.

(51) Int. Cl. G06T 11/60

(52) U.S. Cl. CPC G06T 11/60

(57) ABSTRACT

The technology described herein is directed to artificial intelligence (AI) powered tools that can generate, enhance, and evaluate digital imagery. For example, the AI-powered tools can be used to generate personalized digital illustrations based on user profile information. In some examples, the tools can modify the personalized digital illustrations, such as by modifying a facial expression of a person depicted in the personalized digital illustration to correspond to a mood or tone of the illustration.

### CROSS-REFERENCE TO RELATED APPLICATIONS

The present application claims the benefit of the filing date of U.S. Provisional Patent Application No. 63/535,356, filed Aug. 30, 2023, the disclosure of which is hereby incorporated herein by reference.

### BACKGROUND

Typically, entities create digital content for potential use in reserved content space on a publisher's website or mobile application. The digital content can be part of a digital content campaign. In response to a user's query or other web activity, digital content created by an entity is identified. The identified digital content is typically related to the search query and/or the preferences of the user submitting the search query. Generating imagery for digital content can be time consuming and expensive.

Typically, multiple iterations of the same image are created by rearranging the elements in multiple configurations. Creating multiple iterations of the image requires time, studio space, and the like, which can become expensive and still result in digital content that does not capture all the elements of a product. Further, having to create and edit multiple iterations increases the computational requirements, by having to increase the amount of processing power to create and edit each iteration and having to increase the amount of memory required to store each iteration. Moreover, personalizing content can be even more resource intensive, as creating and storing numerous variations of content for different users requires the multiple iterations for each different user, thereby multiplying the consumption of processing and storage resources.

### BRIEF SUMMARY

The technology described herein is directed to artificial intelligence (AI) powered tools that can generate, enhance, and evaluate digital imagery. For example, the AI-powered tools can be used to generate a personalized digital illustration based on user profile information. In some examples, the tools can modify the personalized digital illustrations, such as by modifying a facial expression of a person depicted in the personalized digital illustration to correspond to a mood or tone of the illustration. By generating the personalized digital illustration using the AI-powered tools, the illustrations can be generated dynamically and varied based on user, context, etc. Moreover, the generation of the illustrations is computationally efficient and storage resource efficient in that numerous variations of content do not need to be pre-generated and stored.

One aspect of the disclosure provides a method for generating a digital illustration, the method comprising receiving, by one or more processors, one or more assets associated with an entity or product; accessing, by the one or more processors, profile information; generating, by the one or more processors based on the asset and the profile information, the digital illustration depicting the entity or product; and generating, by the one or more processors executing an artificial intelligence model, an illustrative depiction of a person in the digital illustration based on the profile information.

In some examples, the person may be the user visualizing the digital illustration. In other examples, the person may be someone associated with the user visualizing the digital illustration, such as a friend or family member.

In some examples, the digital illustration may be a template generated at a first time, wherein the depiction of the person is inserted into the template at a second time later than the first time. The depiction of the person may be dynamically generated when the digital illustration will be displayed to the user.

The method may further include modifying the depiction of the person in the digital illustration to match a facial expression of the person with aspects of the digital image. Such aspects of the digital image may include, for example, one or more of mood, tone, or setting.

The asset may include one or more text, logos, images, audio, or videos.

The artificial intelligence model may be trained using various images of persons,

various images of scenes, and various artistic styles of comics to influence an output accurately depicting the person in the digital illustration.

Generating the illustrative depiction of the person may include, for example, identifying distinguishing features of the person from one or more photos; and interpolating the distinguishing features into a comic representation of the person.

Another aspect of the disclosure provides a non-transitory computer-readable medium storing instructions executable by one or more processors for performing a method of generating a digital illustration. Such method may include receiving one or more assets associated with an entity or product; accessing profile information that is authorized by a user for access; generating, based on the asset and the profile information, the digital illustration depicting the entity or product; and generating, using an artificial intelligence model, an illustrative depiction of a person in the digital illustration based on the profile information.

Yet another aspect of the disclosure provides a system for generating a digital illustration, comprising memory and one or more processors in communication with the memory. The one or more processors may be configured to receive one or more assets associated with an entity or product; access profile information that is authorized by a user for access; generate, based on the asset and the profile information, the digital illustration depicting the entity or product; and generate, by executing an artificial intelligence model, an illustrative depiction of a person in the digital illustration based on the profile information.

The person may be, for example, the user visualizing the digital illustration or someone associated with the user visualizing the digital illustration.

The digital illustration may include a template generated at a first time, wherein the depiction of the person is inserted into the template at a second time later than the first time, wherein the illustrative depiction of the person is dynamically generated when the digital illustration will be displayed to the user.

The one or more processors may be configured to the illustrative depiction of the person in the digital illustration to match a facial expression of the person with aspects of the digital image.

The aspects of the digital image may include, for example, one or more of mood, tone, or setting. The asset may include one or more text, logos, images, audio, or videos.

The artificial intelligence model may be trained using various images of persons, various images of scenes, and various artistic styles of comics to influence an output accurately depicting the person in the digital illustration.

### BRIEF DESCRIPTION OF THE DRAWINGS

FIG. 1 is an example illustration of a digital personalized illustration generated from a set of assets, in accordance with aspects of the disclosure.

FIGS. 2A-2B are examples of digital personalized illustrations generated in accordance with aspects of the disclosure.

FIG. 2C is an example interface with content controls for the digital personalized illustrations according to aspects of the disclosure.

FIG. 2D is an example digital personalized illustration template with defined editing points in accordance with aspects of the disclosure.

FIG. 3 is a block diagram of an example asset analysis and illustration generation system, in accordance with aspects of the disclosure.

FIG. 4 is a block diagram of an example system for implementing aspects of the technology described herein.

FIG. 5 is a block diagram of an example environment for implementing engines within a datacenter, according to aspects of the disclosure.

FIG. 6 is a flow diagram of an example process for generating a personalized digital illustration, according to aspects of the disclosure.

### DETAILED DESCRIPTION

This technology generally relates to tools that leverage artificial intelligence (“AI”), including machine learning and generative AI, to assist with the creation and enhancement of digital illustrations. The tools may include creation tools, including a personalized digital illustration tool to generate new illustrations based on user profile information. The tools may also include enhancement tools, such as personalization tools that may alter the generated illustrations, such as by modifying a facial expression of a person featured in the illustrations. The tools may also include evaluation tools that determine how well the digital illustrations conform with attributes associated with best practices for digital components so the digital illustrations may be edited to increase their effectiveness in engaging users to which the digital illustrations are published.

The tools may be applications, such as a web-based application provided to a client device from a server or a standalone application executing on the client device, or frameworks which may be incorporated into other applications. Moreover, although the tools are described individually herein, each tool may be combined into a single application or framework, or otherwise be implemented in conjunction with other tools within a single application or framework. Further, the tools may be implemented in individual frameworks or applications which may be packaged together.

Although each of the tools described herein is categorized as a creation tool, enhancement tool, or evaluation tool, these categorizations are merely for explanation and reference purposes. Each tool is not limited to the functions of the category to which they are assigned in this disclosure. For instance, the creation tool may create, evaluate, and modify the digital illustration, thereby satisfying each of the three categories.

According to one example implementation, the digital illustration may be a comic depicting the end user. The digital illustration may also depict particular products, services, or other offerings. For example, the digital illustration may depict the user drinking a particular beverage, which may be promoted by an entity associated with the illustration. The illustration may further depict scenery or a situation corresponding to aspects of the user profile. For example, the illustration may depict scenery or a situation relevant to the user's interests, hobbies, lifestyle, family dynamics, etc.

In some examples, a set of generic illustrations may be pre-generated at a first time, such that the generic illustrations can be dynamically modified at a second time, such as when the user illustration will be displayed to the user, to depict a person or other information based on the user profile. By way of example, the pre-generated images may include objects, for example, a bottle positioned at various angles, a car driving and parked, etc. The objects may be generated using assets, such as pictures of the objects or two-dimensional or three-dimensional representations of the objects. Similarly, the person depicted in the illustration may be generated using pictures of the person or other representations.

While in some examples the illustration may depict the user viewing the illustration on a digital display based on the user's profile, in other examples the illustration may depict another person or persons associated with the user or known to the user. For example, the other person may be a celebrity, friend, colleague, or other person associated with the user.

The illustrations may be modified to match a facial expression of the person depicted to a situation, setting, mood, tone, or other aspect of the illustration. For example, if the generated illustration has a relatively serious mood, but images of the user that can be accessed by the tool all depict the user with a smile, the tool can modify a facial expression of the user in the illustration to change the smile to a serious face.

The generated illustration may in some examples be a comic or a comic strip. In other examples, the generated illustration may be an image that is adjusted in other ways, such as by rendering the image in black and white, film grain, or other lighting, filters, etc.

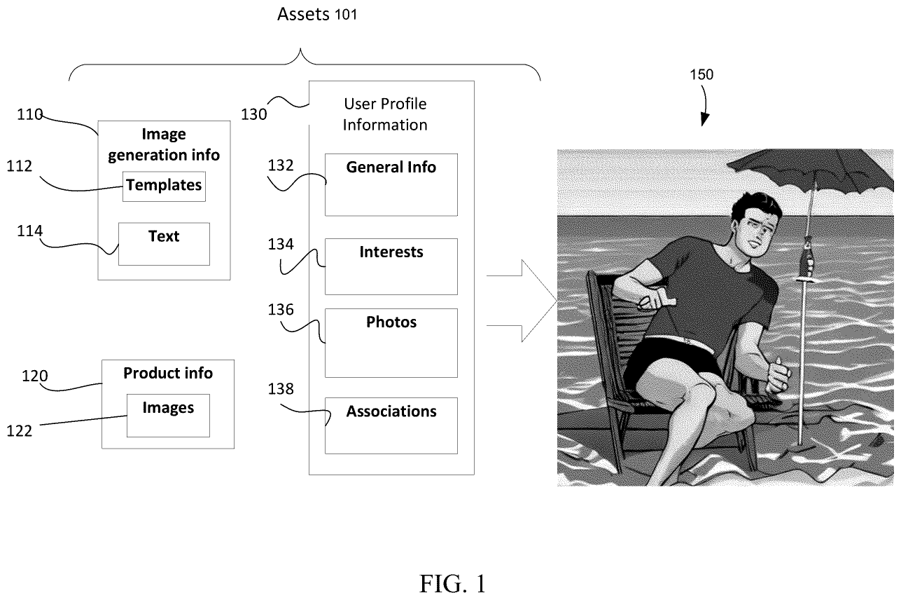

The personalized digital illustration tool may leverage existing assets to generate new personalized digital illustrations. Assets may include text, logos, images, videos, and/or other media. As illustrated in FIG. 1, the assets 101 may include image generation information 110, product information 120, and user profile information 130. Such assets 101 may be used to generate personalized digital image 150, such as a comic or comic strip depicting the user and/or people familiar to the user in a particular setting or scenario.

Image generation information 110 may include, for example, templates 112, text 114, or other assets for generating foundations of the image. The templates 112 may include pre-generated elements, such as background scenery, comment bubbles or dialogue, character placement and posture, audio, etc. In this regard, the template 112 may be combined with user profile information 130 to generate a personalized digital illustration. The text 114 may include text input that can be used to generate an image using artificial intelligence tools. For example, the text input can be a description of a scene as instructions into an AI image generation tool.

Product information 120 can include images 122 or other information associated with products, such as logos, slogans, etc. The images 122 may be images of the product for placement within the personalized digital illustration. The slogans can be used to generate various pre-seeded comic situations, or to set the mood for the situations. Alternatively or additionally, the slogans can appear in the personalized digital illustrations.

User profile information 130 can include any of a variety of types of information associated with a user. Examples of such information may include general information 132, user interests 134, photos 136, associations 138, social actions, activities, profession, geographic information, or any of a variety of other types of information. The user may be provided with controls allowing the user to authorize or prevent access to user profile information. For example, the controls may allow the user to make an election as to whether the user profile information is accessed, or to select particular types of profile information that may be accessed. For example, the user may elect to permit access to user interests 134 but not photos 136. As another example, the user may elect to permit access to some photos but not others. Accordingly, access to the user profile information 130 may be limited by the user, such that only the user profile information permitted by the user is used for generating the personalized digital illustration.

The general information 132 may include, for example, basic data pertaining to the user such as name, age, or the like.

The user interests 134 may indicate the user's preferences, hobbies, activities, etc. Such interests may relate to various topics, such as food, clothing, sports, travel, wellness, occupation, education, etc. The user interests 134 may be manually input by the user, or determined through passive user activity.

Photos 136 may include photos captured and stored by the user, or photos captured by other persons associated with the user. For example, connections on a social network may capture photos that include the user. The user may be tagged in metadata for the photos.

Associations 138 may refer to any persons or things associated with the user. For example, the associations 138 can include subscriptions, memberships, clubs, or other organizations to which the user belongs. As another example, the associations 138 can include other persons to which the user is linked, such as social media connections, contacts, interactions, etc.

While several example types of user profile information 130 are illustrated, it should be understood that various other types of user profile information may be included. Similarly, it should be understood that assets 101 are non-limiting examples, and other types of assets may be included, including audio assets. Further, while several examples of assets 101 are shown in the example of FIG. 1, any number of assets may be included.

The personalized digital illustration tool may analyze the assets 101 to identify a subset of assets for inclusion in the illustration 150. The subset of assets may be those determined to satisfy certain criteria, such as those matching an intent for which the personalized digital illustration is created. For instance, if the personalized digital illustration is intended to highlight a product and illustrate how that product might be used by a user, the personalized digital illustration tool may select a subset of assets including product images 122, user interests 134, and photos 136.

The personalized digital illustration tool may combine some or all of the subset of assets into a new digital component. For instance, as illustrated in FIG. 1, the illustration 150 may be generated based on the subset of assets including image generation information 110, product information 120, and user profile information 130.

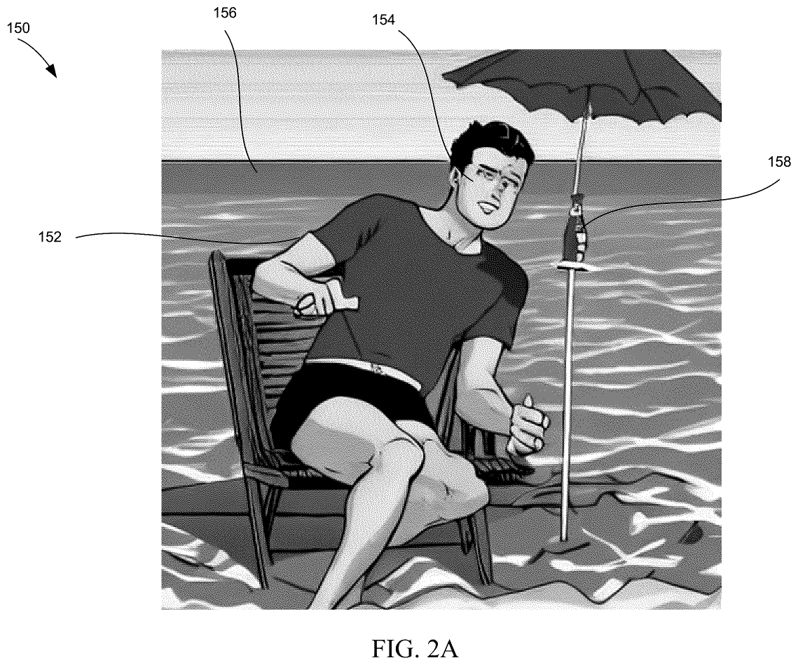

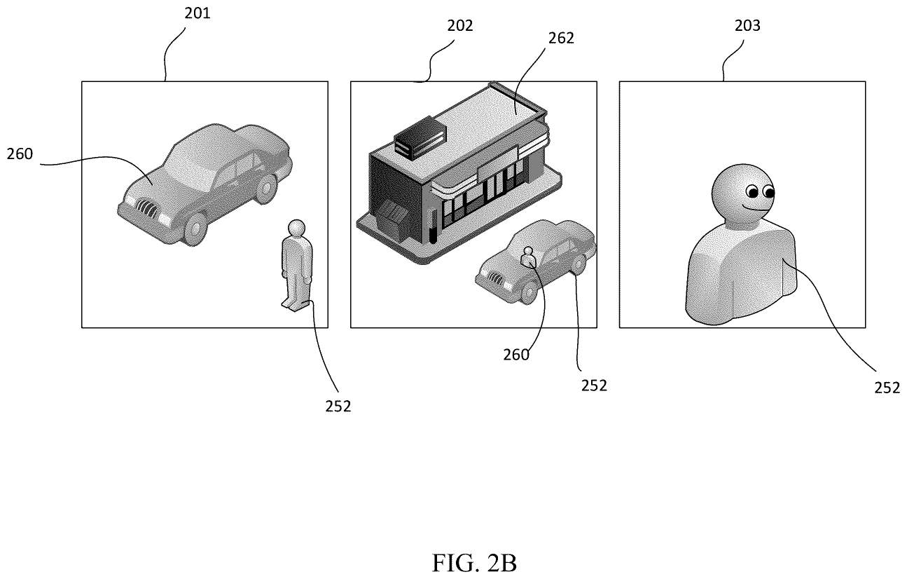

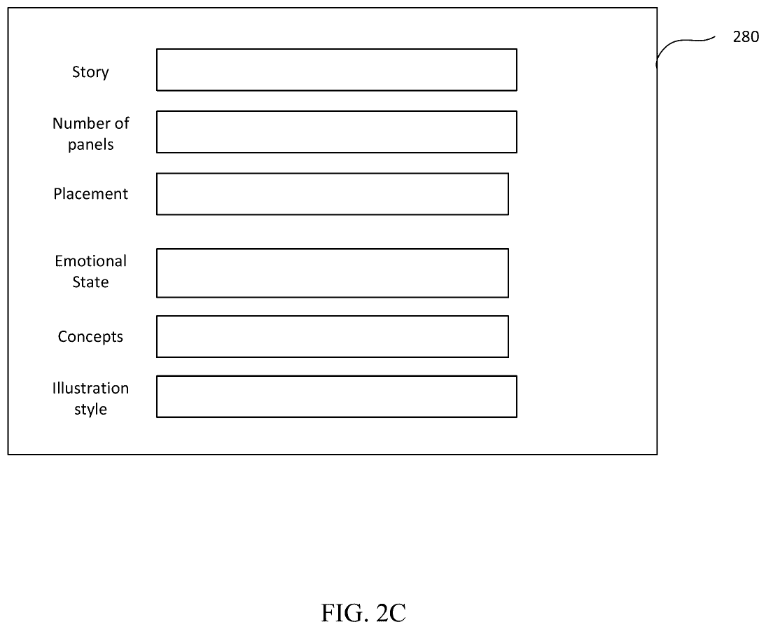

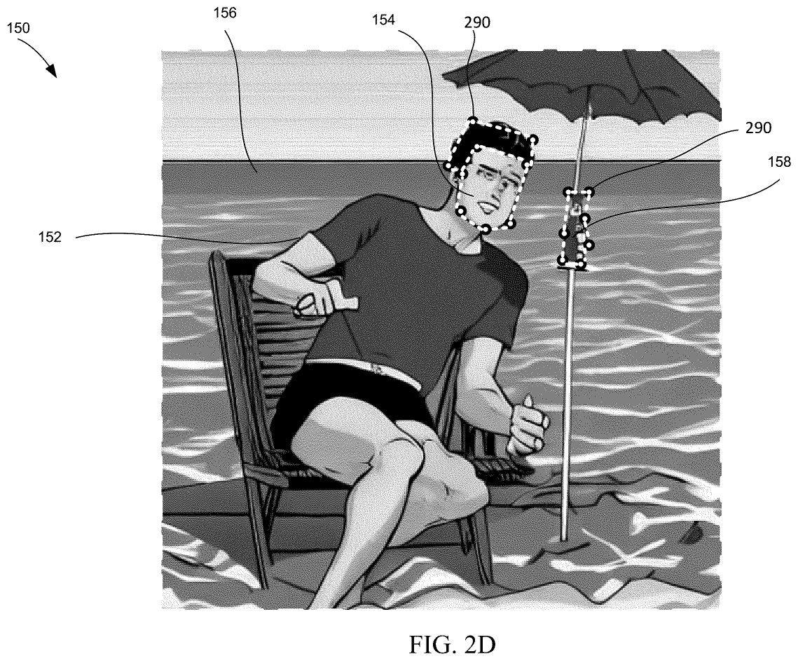

As shown in FIG. 2A, the personalized digital illustration 150 includes a scene 156. In this example, the scene 156 includes a beach chair and umbrella at the edge of the ocean with the horizon in the background. The personalized digital illustration 150 further includes a person 152. The person 152 may be generated to resemble the user or someone known to the user. While one person 152 is shown in the example of FIG. 2A, in other examples any number of people may be depicted. In other examples, the illustration may be generated without depicting any people. For example, the illustration may instead depict objects familiar to the user, such as a car, bicycle, pet, etc.

The person 152 is depicted with a facial expression 154. The facial expression 154 may be generated to match the mood, tone, vibe, etc. of the illustration 150. For example, the photos from the user profile used as assets to generate the illustration 150 may depict the user having a surprised expression, but the scene 156 has a relaxed vibe. Accordingly, the personalized digital illustration tool may modify the facial expression 154 of the person 152 depicted to have a more relaxed and happy expression.

Depiction of the person 152 and facial expression 154 may be generated by identifying distinguishing characteristics of the person from user profile photos or other descriptors, such as text, etc., and interpolating the distinguishing characteristics into comic form. The distinguishing characteristics may be determined by, for example, identifying reference points on the face of one or more photos, and determining spatial relationships of the reference points. For example, reference points can be identified at corners of a person's eyes, around their nose, at eyebrows, edges of face, cheekbones, corners of mouth etc. Relative positioning and distances between such points may be determined, and used to generate a comic version of the person. In some examples, the reference points and related information may be compared to a set to determine which features are more distinctive. For example, the set may include reference points and related information for a number of people, such that by comparison outlying reference points can be determined and used to identify distinctive facial features. In other examples, distinctive facial features or other traits may be determined using other techniques, such as depth perception, color mapping, etc.

The personalized digital illustration may also depict a product 158. The depiction of the product 158 may be generated from one or more product images and positioned within the scene 156. According to some examples, the product 158 may be generated from a plurality of components. For example, components for a bottle may include images of a plain bottle, a logo, a label, color schemes, etc. which may be selectively assembled to create a representation of the product. While the product 158 is illustrated as a bottle in FIG. 2, it should be understood that the product 158 may take any of a variety of forms. Moreover, the product may be omitted and/or replaced with text, such as logos, slogans, etc. For example, if the illustration 150 is intended to promote a service, the scene 156 may be generated to reflect an aspect of the service and text related to the service may be displayed.

The generated image 150 may be a comic, cartoon, series of illustrations such as in a comic strip, video, or other type of illustration. The image 150 may have a variety of artistic styles, such as pop-art, surreal, photorealistic, three-dimensional, cinematic, manga, film grain, caricature, black and white etc. Moreover, the illustration can reflect any of a variety of moods or tones, such as whimsical, dark, happy, somber, intense, etc.

Though not shown, in some examples the personalized digital illustration may be accompanied by audio. For example, the audio may include music, dialogue, background sounds, or other sounds. With reference to FIG. 2A, accompanying audio may include, for example, sounds of waves crashing, seagulls, gentle music, and dialogue describing the product 158.

According to some examples, one or more generated scenes may be stored as templates, such that personalized features corresponding to the user may be added prior to publishing on a website or mobile application, rather than re-generating the entire personalized digital image. For example, with respect to FIG. 2A, the scene 156 including horizon, waves, sand, umbrella, and chair, may be saved as a template. In some examples, the product 158 may also be included in the template. In this regard, prior to publishing, a personalized illustration may be inserted into the template. The personalized illustration may be, for example, a cartoon or comic or other drawing resembling the user or one or more persons familiar to the user. The personalized illustration may be generated using photos or other information in the user profile. In some examples, portions of a person may be included in the template, such that only remaining portions may be added prior to publishing. For example, the template may include a body and be updated with a head and facial features corresponding to the user prior to publishing. In some instances, several variations of templates may be stored, such that a particular template is selected and updated prior to publication. For example, variations may include the same scene but several different variations of body types, such that the template having a body type most closely corresponding to the user may be selected and updated prior to publication. As another example, variations may include different scenes, such that a scene most closely matching a user's interests may be selected and updated prior to publication. For example, one variation of a scene may include a beach while another variation includes a sporting event and another variation includes driving in a car. Based on the user's profile, the variation most closely correlated with the user's lifestyle or interests may be selected and updated with a personalized illustration corresponding to the user prior to publication.

Whether generating an illustration corresponding to the user for insertion into a template, or generating an entire scene including an illustration corresponding to the user, a facial expression in the generated illustration may be generated to match a mood, tone, vibe, etc. of the scene. Such matching can include determining a mood, tone, vibe, etc. of the scene and altering a facial expression of a user photo from the user profile to correspond to the determined mood, tone, or vibe.

Determining the mood, tone, vibe can include analyzing the generated scene, such as using image recognition, machine learning models, etc. In other examples, determining the mood, tone, vibe can include identifying corresponding metadata indicating the mood, tone, vibe. In further examples, determining the mood, tone, vibe can be based on text or other input used in generating the scene. For example, text instructions, user interests, or other input may have an associated mood, tone, vibe that can be detected.

Altering the facial expression can include first generating a digital illustration based on a user photo that resembles the user photo and then second modifying facial features in the generated digital illustration, such as by moving corners of a mouth, moving eyebrows, modifying eye shape, modifying cheekbone prominence, modifying forehead/eye/mouth wrinkles, etc. In some examples, the facial features can be repeatedly adjusted until the facial expression is correct. For example, object recognition tools can be used to determine if the facial expression is correct. Feedback may be provided to the illustration generation system to modify the illustration further. In other examples, the facial features can be modified as the illustration is generated in the first instance.

Though not shown in FIG. 2A, in some examples the personalized digital illustration can include other components, such as text or comment bubbles, dialogue, etc. Such text or comments can be generated based on the product, an intended purpose for the digital illustration, user profile information, and/or any of a variety of other types of information.

In some instances, the personalized digital illustration creation tool may analyze the assets of the user's profile and generate an image that corresponds to the user's interests. For example, if the tool determines that the user has an interest in travel, the scene 156 of the generated image may depict a travel destination. As another example, if the tool determines that the user has an interest in reading, it may generate an image depicting the user reading a book. In some instances, assets contained within other assets may be identified, stored, and/or otherwise retrieved by artificial intelligence models trained to identify particular asset types, visual and textual recognition algorithms, etc.

The personalized digital illustration creation tool may identify a subset of assets to include in the digital illustration, determine the characteristics and interests of a user, and generate personalized digital illustrations using machine learning models. These machine learning models can be implemented in a system, such as an asset analysis and illustration generation system, which may be implemented as part of the personalized digital illustration creation tool.

Example machine-learning models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts, etc.) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

According to some examples, the models used to generate personalized digital illustrations may receive as input multiple images as prompts for generating the personalized digital illustration. For example, the images can include one or more images of a person to be depicted and one or more images of an object to be depicted. The prompt may also include text or audible cues, such as instructions as to how the illustrations should appear, e.g., background, pose, vibe, mood, etc. Multiple images of the person or object taken from different angles may be used to generate a 3D view reconstruction model of the person or object. The personalized digital illustration model can select an image of the person and/or object that has a corresponding angle. If no angles of the person and object match from the 3D reconstruction models, the closest product image may be used or an image having the appropriate viewing angle may be generated by the 3D view reconstruction model.

In some examples, a depiction of the person may be generated first in an image, and a portion of the image may be selected for depiction of the object. For example, in an illustration of the person sitting in a beach chair, the person's hand may be selected for placement of the object, or a table next to the person may be selected for placement of the object, etc. The image may be modified to generate a depiction of the object in the selected region based on the one or more input images of the object. Similarly, in other examples the personalized digital illustration may be generated to depict the scenery and object first based on input to the model, and a portion may be selected for placement of the person. The person may be depicted in the selected portion using image editing.

In some examples, rather than generating the personalized digital illustration to depict a person resembling an intended viewer of the illustration, the personalized digital illustration may be generated to depict a person resembling a friend or family member of the intended viewer. For example, images input to the model may include images of the viewer's grandparent if the depicted object is more likely to be relevant to the viewer's grandparent than to the viewer. In one example implementation of generating such an illustration, characters and product scenario can be extracted from an initial creative. The extracted details can be used along with a desired style, e.g., indicated by a text or verbal prompt, as input to the model. In another example implementation, the initial creative and desired style may be used directly as inputs to the model. The desired style may be indicated in the form of a text or audio prompt, and/or an example image showing the style, etc.

The model may be fine-tuned in any of a number of ways. As one example, a user may provide a set of creatives to fine-tune the model. Examples of such creatives may include a T-shirt under multiple lightings, front/back color schemes, different body types, etc. As another example, a user can prompt the model to depict the object in various situations and personas and comic drawing styles. As another example, a user can select from an existing library of personas or create a new persona to test the rendering of the object in situations.

According to some examples, multiple layers of imagery may be used in a template, such that some layers may be replaced to personalize the illustration without generating an entire image. For example, the image 150 may include multiple layers of imagery. By way of example, a first layer may include the scene 156, a second layer may include person 152, a third layer may include features of the person 152, and a fourth layer may include product 158. The features of the person 152 may be any features, such as facial expression 154, hair, clothing, etc. In this regard, individual layers may be replaced with personalized layers without expending the processing power of generating an entire personalized image. For example, a layer with the person's clothing can be replaced with different clothing, such as having a different color, cut, pattern, style, logo, etc. As another example, a layer with the product can be replaced with a different product. For example, instead of illustrating a bottled beverage next to the person 152, the image can be modified to illustrate a different beverage, sunglasses, accessory, electronic device, or any other object.

While the example of FIG. 2A illustrates an example of a digital illustration including a single panel, in other examples the digital illustration may include multiple panels, such as in a comic strip. For example, FIG. 2B illustrates a multi-panel digital illustration including a first panel 201, second panel 202, and third panel 203. While three panels are included in this example, it should be understood that any number of panels may be included. The multi-panel digital illustrations may present a story by illustrating a sequence of scenes and/or character activity. In the example shown, the first panel 201 depicts a user 252 looking at a car 260, such as a car the user 252 desires to purchase. Second panel 202 depicts a real-life situation relevant to the user 252 that includes the car 260, such as how the user 252 is likely to use the car 260. In this example, the second panel 202 depicts the user 252 driving the car 260 to a store 262. The situation depicted can vary based on the user's profile information. For example, while a first user may typically drive to a grocery store, a second user may typically order their groceries online. The second user may be more likely to use a car for commuting to work or taking weekend road trips. Accordingly, a digital illustration generated for the second user may depict the second user performing a different activity that involves the car 260. The third panel 203 depicts the user 252 feeling happy and satisfied that they accomplished their errands using the car 260.

In each of the first, second, and third panels 201-203, the user 252 may be depicted in comic style, such that the illustration includes a character resembling the user. The illustration may be generated as described above, based on user profile information. For example, photos may be used to generate an illustration resembling the user, while interests and activity may be used to determine the story depicted.

Though not shown, other types of format for the digital illustration are also possible. For example, rather than a single or multi-panel illustration, the digital illustration may be a graphics interchange format (GIF), video, or other format.

According to some examples, the story depicted and/or other aspects of the digital illustration may be controlled by an entity. For example, the entity may be associated with a product or service highlighted in the illustration, such as the beverage 158 of FIG. 2A or the car 260 of FIG. 2B. FIG. 2C illustrates an example of content controls 280 that may be supplied for the entity through a user interface. The content controls 280 may define one or more parameters that outline how the digital illustration may be generated and displayed. Such parameters may relate to the story that will be delivered in the illustration, the number of panels to include, placement of the illustration on a web page or mobile application, placement of a product depicted in the illustration, an emotional state to be conveyed through the illustrated character, concepts to be depicted, such as whether to include friends in the depiction or not, comic style, etc. While these are merely a few examples of parameters, it should be understood that any of a variety of other parameters may be included. According to some examples, the entity can pre-authorize one or more templates illustrating a desired story, product placement, etc.

According to some examples, a template image may include one or more editing points for modifying the image without generating an entire new personalized image. For example, in FIG. 2D the image 150 may include editing points 290. The editing points 290 may designate portions of the image 150 for modification, such that the modification is limited to a discrete portion of the image without affecting the entirety of the image 152. In this regard, the modification can be performed efficiently, using less processing power by limiting the amount of modification. The editing points 290 may be stored as metadata in association with the image 150. The editing points 290 may be accessed by a machine learning model in performing modification of the image, such as to identify the particular portions of the image for editing.

The editing points 290 may be determined manually after generation of the image 150. In other examples, the editing points can be determined automatically by the machine learning model as part of the image generation process or as a post image generation process. For example, the machine learning model may be trained to recognize and extract particular characteristics, such as facial features, expressions, scenes, etc. Based on such recognition and extraction, the editing points 290 can be defined. For example, the editing points 290 can define a boundary around the recognized characteristics.

In the example shown, the editing points 290 define portions of the image 150 around the product 158, the facial expression 154 of the person 152, and the hair of the person 152. In other examples, the editing points 290 can define any other portions of the image, such as other objects in the scene, the person's clothing, other personal features, etc. By accessing the editing points 290 during personalization of the image, the machine learning model can quickly replace the portions to more closely approximate a different person, expression, product, etc.

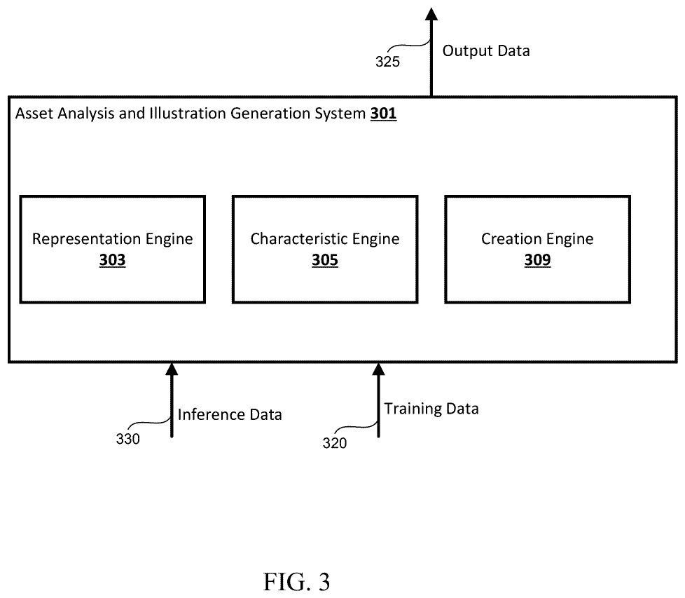

FIG. 3 depicts a block diagram of an example asset analysis and illustration generation system 301, which can be implemented on one or more computing devices. The system 301 can be configured to receive inference data 330 and/or training data 320 for use in identifying subsets of assets to include in the personalized digital illustrations, determining characteristics and interests of users, and generating personalized digital illustrations. For example, the system 301 can receive the inference data 330 and/or training data 320 as part of a call to an application programming interface (API) exposing the system 301 to one or more computing devices. Inference data 330 and/or training data 320 can also be provided to the system 301 through a storage medium, such as remote storage connected to the one or more computing devices over a network. Inference data 330 and/or training data 320 can further be provided as input through a user interface on a client computing device coupled to the system 301. The inference data 330 can include the assets associated with the user for which the personalized digital illustrations creation tool is generating a personalized digital illustration.

The system 301 can include one or more engines, also referred to herein as modules and/or models, configured to identify subsets of assets to include in personalized digital illustrations, determine characteristics and interests of users, and/or generate personalized digital illustrations. In this regard, system 301 includes representation engine 303, characteristic engine 305, and creation engine 309. The representation engine 303 may be trained to identify subsets of assets to include in personalized digital illustrations. The characteristic engine 305 may be trained to determine characteristics associated with a user and interests of a user. The creation engine 309 may be trained to generate personalized digital illustrations from a collection of assets for a user.

Engines 303-309 may be implemented as one or more computer programs, specially configured electronic circuitry or any combination thereof. Although FIG. 3 illustrates the system 301 as having three engines, including a representation engine 303, characteristic engine 305, and creation engine 309, the system 301 may have any number of engines. Moreover, the functionality of the engines described herein may be combined within one or more engines. Although engines 303-309 are all shown as being in a single system 301, the engines may be implemented in more than one system.

Moreover, engines 303-309 may work in tandem and/or cooperatively. For instance, the characteristic engine 305 may provide outputs to the representation engine 303 for use in selecting assets to include in a personalized digital illustration. The representation engine, in turn, may provide the selected assets to creation engine 309 for generating a personalized digital illustration.

The training data 320 can correspond to an artificial intelligence (AI) or machine learning (ML) task for identifying subsets of assets to include in personalized digital illustrations, determining characteristics and personalities of entities, generating video components, and other such tasks performed by engines 303-309. The training data 320 can be split into a training set, a validation set, and/or a testing set. An example training/validation/testing split can be an 80/10/10 split, although any other split may be possible. The training data for the representation engine 303 can include examples of assets that have been selected and not selected for inclusion in video components previously. The training data for the characteristic engine 305 may include assets including and not including characteristics and interests of users. The training data for generating personalized digital illustrations may include previously created personalized digital illustrations and, in some instances, data defining where, when, and/or how assets were incorporated into the previously created personalized digital illustrations.

The training data 320 can be in any form suitable for training an engine, according to one of a variety of different learning techniques. Learning techniques for training an engine can include supervised learning, unsupervised learning, and semi-supervised learning techniques. For example, the training data 320 can include multiple training examples that can be received as input by an engine. By way of example, the training data 320 can include comics of a variety of artistic styles, diverse general images such as images of scenes, diverse images of persons, images related to a particular product domain (e.g., beach settings and activities for seaside related products), etc.

The training examples can be labeled with a desired output for the engine when processing the labeled training examples. For instance, and with reference to training data for determining which assets to include in a generated personalized digital illustration, assets that have been previously selected for inclusion in a personalized digital illustration may be labeled as such, whereas assets not selected for inclusion in a personalized digital illustration may be labeled as such.

The label and the engine output can be evaluated through a loss function to determine an error, which can be backpropagated through the engine to update weights for the engine. For example, if the machine learning task is a classification task corresponding to determining characteristics of an entity, the training examples can be images labeled with one or more classes categorizing characteristics depicted in provided assets. As another example, a supervised learning technique can be applied to calculate an error between outputs, with a ground-truth label of a training example processed by the engine. Any of a variety of loss or error functions appropriate for the type of task the engine is being trained for can be utilized, such as cross-entropy loss for classification tasks, or mean square error for regression tasks. The gradient of the error with respect to the different weights of the candidate engine on candidate hardware can be calculated, for example using a backpropagation algorithm, and the weights for the engine can be updated. The engine can be trained until stopping criteria are met, such as a number of iterations for training, a maximum period of time, a convergence, or when a minimum accuracy threshold is met.

In addition to training data 320, having data available at inference time can also be beneficial to control or influence the output. For example, having access to pictures of a user will allow generation of an image of the user with more fidelity. Having images of the user with different facial expressions will improve the facial expressions generated of the user. These images may be processed, such as through labelling/captioning by image understanding machine learning models.

From the inference data 330 and/or training data 320, the system 301 can be configured to output one or more results related to identifying subsets of assets to include in personalized digital illustrations, determining characteristics and interests of users, and/or generating personalized digital illustrations, generated as output data 325. As an example, the output data 325 can be any kind of score, classification, or regression output based on the input data that is output by engines 303-309. Correspondingly, the AI or machine learning task can be a scoring, classification, and/or regression task for predicting some output given some input.

These AI or machine learning tasks can correspond to a variety of different applications in processing images, video, text, speech, or other types of data to identify subsets of assets to include in personalized digital illustrations, determine characteristics and interests of users, and/or generate personalized digital illustrations. The output data 325 can include instructions associated with these tasks. For instance, the creation engine 309 may be configured to provide the output data 325 as a set of computer-readable instructions, such as one or more computer programs, which can be executed by a computing device to generate a personalized digital illustration with the selected assets and features determined by the creation engine 309. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement the functionality described herein, for example, as performed by a system, engine, module, or model. The system 301 can further be configured to forward the output data to one or more other devices configured for translating the output data into an executable program written in a computer programming language. The system 301 can also be configured to send the output data to a storage device for storage and later retrieval. Additionally, or alternatively, the asset creation tool may be configured to receive the output of the system 301 for further processing and/or implementation.

An illustration evaluation tool may be used to analyze personalized digital illustrations. The illustration evaluation tool may provide feedback, such as recommendations for improving the personalized digital illustration.

The evaluation tool may compare the personalized digital illustrations to actual photos, templates, standards, or other information. The evaluation tool may provide feedback, such as recommendations for improving the personalized digital illustration.

The evaluation tool may analyze illustrations using machine learning models. These machine learning models can be implemented in a system as part of the illustration creation tool. Alternatively, or additionally, some of the evaluation tool may be implemented as a separate program(s) or system(s) from the illustration creation tool.

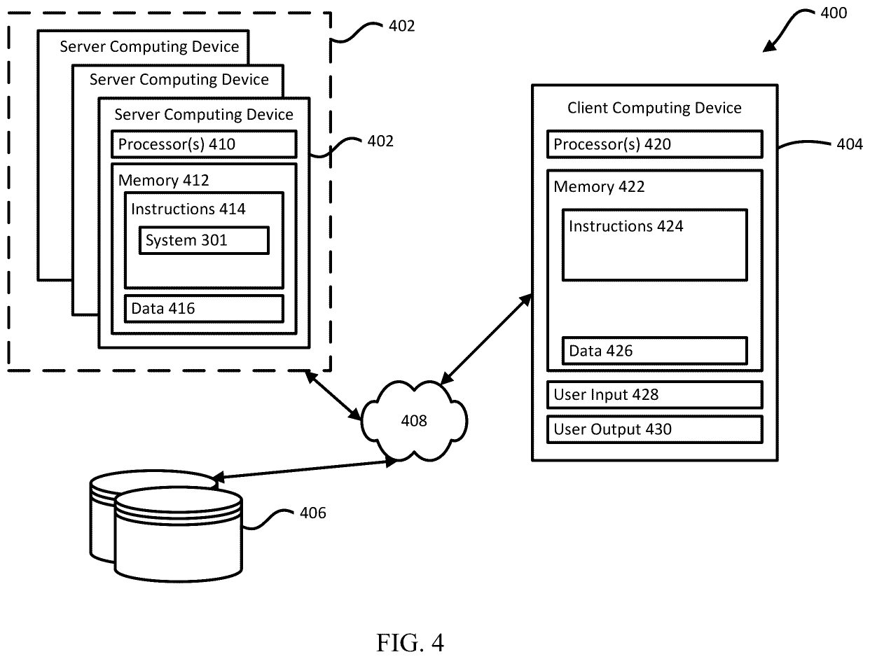

FIG. 4 depicts a block diagram of an example environment 400 for implementing the systems and applications described herein such as the illustration generation system 301, including the creation tool and evaluation tool. The system 400 can be implemented on one or more computing devices having one or more processors in one or more locations, such as in server computing device 402 and client computing device 404. Client computing device 404 and the server computing device 402 can be communicatively coupled to one or more storage devices 406 over a network 408. The storage device 406 can be a combination of volatile and non-volatile memory and can be at the same or different physical locations than the computing devices 402, 404. For example, the storage devices 406 can include any type of non-transitory computer readable medium capable of storing information, such as a hard-drive, solid state drive, tape drive, optical storage, memory card, ROM, RAM, DVD, CD-ROM, write-capable, and read-only memories. The storage device 406 may store assets, video components, and other data discussed herein.

The server computing device 402 can include one or more processors 410 and memory 412. The memory 412 can store information accessible by the processors 410, including instructions 414 that can be executed by the processors 410. The memory 412 can also include data 416 that can be retrieved, manipulated, or stored by the processors 410. The memory 412 can be a type of non-transitory computer readable medium capable of storing information accessible by the processors 410, such as volatile and non-volatile memory. The processors 410 can include one or more central processing units (CPUs), graphic processing units (GPUs), field-programmable gate arrays (FPGAs), and/or application-specific integrated circuits (ASICs), such as tensor processing units (TPUs).

The instructions 414 can include one or more instructions that, when executed by the processors 410, cause the one or more processors to perform actions defined by the instructions 414. The instructions 414 can be stored in object code format for direct processing by the processors 410, or in other formats including interpretable scripts or collections of independent source code modules that are interpreted on demand or compiled in advance. Instructions 414 can include instructions for implementing a personalized digital illustration generation system 301. The system 301 can be executed using the processors 410, and/or using other processors remotely located from the server computing device 402. Although the system 301 are shown as being executed by server computing device 402, the system 301 can be executed by a client computing device, such as client computing device 404.

The data 416 can be retrieved, stored, or modified by the processors 410 in accordance with the instructions 414. The data 416 can be stored in computer registers, in a relational or non-relational database as a table having a plurality of different fields and records, or as JSON, YAML, protobuf, or XML documents. The data 416 can also be formatted in a computer-readable format such as, but not limited to, binary values, ASCII, or Unicode. Moreover, the data 416 can include information sufficient to identify relevant information, such as numbers, descriptive text, proprietary codes, pointers, references to data stored in other memories, including other network locations, or information that is used by a function to calculate relevant data. For instance, the data may include training data, inference data, illustrations, assets, etc.

The client computing device 404 can be configured similarly to the server computing device 402, with one or more processors 420, memory 422, instructions 424 (such as the enterprise application, which may additionally or alternatively, be executed by the server computing device 402), and data 426. The client computing device 404 can also include a user input 428 and a user output 430. The user input 428 can include any appropriate mechanism or technique for receiving input from a user, such as keyboard, mouse, mechanical actuators, soft actuators, touchscreens, microphones, and sensors.

The server computing device 402 and client computing device 404 can be configured to transmit and receive data to and from each other device. In some instances, the client computing device 404 can be configured to display at least a portion of the received data from the server computing device 402, on a display implemented as part of the user output 430. The user output 430 can also be used for displaying an interface between the client computing device 404 and the server computing device 402. The user output 430 can alternatively or additionally include one or more speakers, transducers, or other audio outputs, a haptic interface or other tactile feedback that provides non-visual and non-audible information to the platform user of the client computing device 404.

Although FIG. 4 illustrates the processors 410, 420 and the memories 412, 422 as being within the computing devices 402, 404, components described herein can include multiple processors and memories that can operate in different physical locations and not within the same computing device. For example, some of the instructions 414, 424 and the data 416, 426 can be stored on a removable SD card and others within a read-only computer chip. Some or all of the instructions and data can be stored in a location physically remote from, yet still accessible by, the processors 410, 420. Similarly, the processors 410, 420 can include a collection of processors that can perform concurrent and/or sequential operation. The computing devices 402, 404 can each include one or more internal clocks providing timing information, which can be used for time measurement for operations and programs run by the computing devices 402, 404

The server computing device 402 can be connected over the network 408 to a datacenter (not shown) housing any number of hardware accelerators. The datacenter can be one of multiple datacenters or other facilities in which various types of computing devices, such as hardware accelerators, are located. Computing resources housed in the datacenter can be specified for deploying models, such as the engines described herein.

The server computing device 402 can be configured to receive requests to process data from the client computing device 404 on computing resources in the datacenter. For example, the environment 400 can be part of a computing platform configured to provide a variety of services to users, through various user interfaces and/or application programming interfaces (APIs) exposing the platform services. The variety of services can include creating, enhancing, and analyzing personalized digital illustrations. In one example, the client computing device 404 can transmit data specifying requests for services. The server computing system 402 can receive the request, and in response, use the system 301 to generate a response.

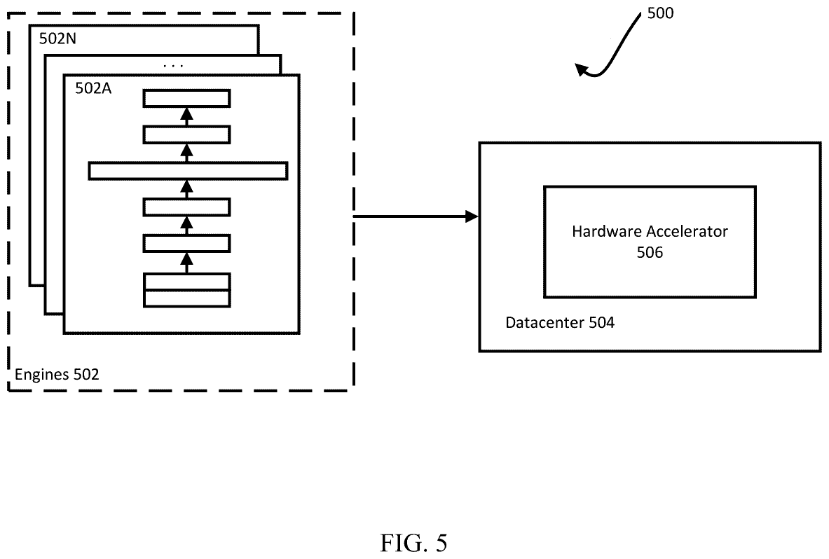

FIG. 5 depicts a block diagram 500 illustrating one or more engine architectures 802, more specifically 502A-N for each architecture, for deployment in a datacenter 504 housing a hardware accelerator 506 on which the deployed engines 502 will execute. The hardware accelerator 506 can be any type of processor, such as a CPU, GPU, FPGA, or ASIC such as a TPU.

An architecture 502 of an engine can refer to characteristics defining the engine, such as characteristics of layers for the models, how the layers process input, or how the layers interact with one another. The architecture 502 of the engine can also define types of operations performed within each layer. One or more architectures 502 can be generated that can output results.

Referring back to FIG. 4, the computing devices 402, 404, and the datacenter can be capable of direct and indirect communication over the network 408. For example, using a network socket, the client computing device 404 can connect to a service operating in the datacenter through an Internet protocol. The computing devices 402, 404 can set up listening sockets that may accept an initiating connection for sending and receiving information. The network 508 itself can include various configurations and protocols including the Internet, World Wide Web, intranets, virtual private networks, wide area networks, local networks, and private networks using communication protocols proprietary to one or more companies. The network 508 can support a variety of short-and long-range connections. The short-and long-range connections may be made over different bandwidths, such as 2.402 GHz to 2.480 GHz, commonly associated with the Bluetooth® standard, 2.4 GHz and 5 GHZ, commonly associated with the Wi-Fi® communication protocol; or with a variety of communication standards, such as the LTE® standard for wireless broadband communication. The network 408, in addition or alternatively, can also support wired connections between the computing devices 402, 404 and the datacenter, including over various types of Ethernet connections.

Although a single client computing device 404 is shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing engines, and any combination thereof.

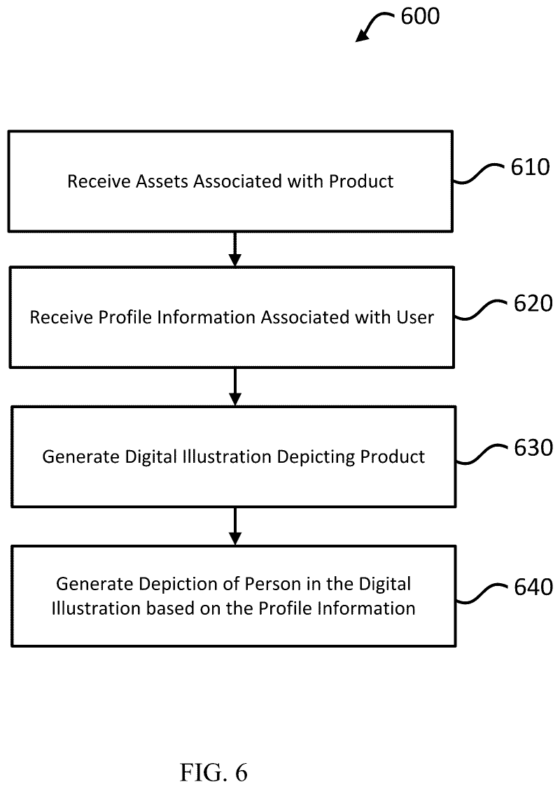

FIG. 6 illustrates a method 600 for generating personalized digital illustrations. The method may be performed by one or more processors, and may implement one or more AI or ML models. While operations of the method 600 are described in a particular order, it should be understood that operations may be performed in a different order or simultaneously. Moreover, operations may be added or omitted.

In block 610, assets associated with a product or entity are received. The product may be, for example, an offering to be highlighted in the digital illustration. The entity may be, for example, a company, business, individual, or other entity associated with the product or offering services to be highlighted by the digital illustration. Assets associated with the product or entity may include, for example, images of the product, logos, labels, text, or the like.

In block 620, profile information associated with the user is received, if sharing of such profile information is authorized by the user. The user may be provided with controls allowing the user to authorize or prevent access to user profile information. For example, the controls may allow the user to make an election as to whether the user profile information is accessed, or to select particular types of profile information that may be accessed. The user profile information may include, for example, general user information, interests, photos, connections, etc.

In block 630, a digital illustration is generated depicting the product or other objects related to the entity. The digital illustration may be generated using AI models, such as machine learning models. The digital illustration may be a template including a scene, the product, and a space for insertion of a representation of one or more persons. The digital illustration may be stored with associated metadata indicating, for example, the product, entity, or characteristics of the illustration, such as mood, tone, vibe, scene, objects depicted, timestamp of creation, etc.

In block 640, a depiction of a person may be generated in the digital illustration. The depiction may be generated based on user profile information, such as photos of the user, photos of connections, characteristics of the user and/or connections, etc. The depiction may be generated as a comic or cartoon. An illustration style of the depiction of the person may match an illustration style of the generated digital image including the scene, product, etc. In some examples, the digital illustration of the scene may be generated at the same time as generation of the depiction of the person. The illustration, including the scene, product, and/or depiction of the person, may be modified to improve features of the illustration. For example, the image may be modified to adjust a facial expression of the depiction of the person to match the mood, tone, vibe of the scene. As another example, the image may be modified to adjust aspects of the illustration that are inaccurate. For example, shadows, lines, shapes, or other representations that are out of place or otherwise inaccurate may be corrected. Feedback regarding the updates or adjustments may be input to the AI model for improved generation of future digital illustrations.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as a TensorFlow framework, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front-end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for generating a digital illustration, the method comprising:
receiving, by one or more processors, one or more assets associated with an entity or product;
accessing, by the one or more processors, profile information;
generating, by the one or more processors based on the asset and the profile information, the digital illustration depicting the entity or product; and
generating, by the one or more processors executing an artificial intelligence model, an illustrative depiction of a person in the digital illustration based on the profile information.

2. The method of claim 1, wherein the person is a user visualizing the digital illustration.

3. The method of claim 1, wherein the person is someone associated with a user visualizing the digital illustration.

4. The method of claim 1, wherein the digital illustration comprises a template generated at a first time, and the depiction of the person is inserted into the template at a second time later than the first time.

5. The method of claim 4, wherein the depiction of the person is dynamically generated when the digital illustration will be displayed to a user.

6. The method of claim 1, further comprising modifying the depiction of the person in the digital illustration to match a facial expression of the person with aspects of the digital image.

7. The method of claim 6, wherein the aspects of the digital image comprise one or more of mood, tone, or setting.

8. The method of claim 1, wherein the asset includes one or more text, logos, images, audio, or videos.

9. The method of claim 1, wherein the artificial intelligence model is trained using various images of persons, various images of scenes, and various artistic styles of comics to influence an output accurately depicting the person in the digital illustration.

10. The method of claim 1, wherein generating the illustrative depiction of the person comprises:
identifying distinguishing features of the person from one or more photos or other descriptors; and
interpolating the distinguishing features into a comic representation of the person.

11. A non-transitory computer-readable medium storing instructions executable by one or more processors for performing a method of generating a digital illustration, the method comprising:
receiving one or more assets associated with an entity or product;
accessing profile information that is authorized by a user for access;
generating, based on the asset and the profile information, the digital illustration depicting the entity or product; and
generating, using an artificial intelligence model, an illustrative depiction of a person in the digital illustration based on the profile information.

12. A system for generating a digital illustration, comprising:
memory; and
one or more processors in communication with the memory and configured to:
receive one or more assets associated with an entity or product;
access profile information that is authorized by a user for access;
generate, based on the asset and the profile information, the digital illustration depicting the entity or product; and
generate, by executing an artificial intelligence model, an illustrative depiction of a person in the digital illustration based on the profile information.

13. The system of claim 12, wherein the person is the user visualizing the digital illustration.

14. The system of claim 12, wherein the person is someone associated with the user visualizing the digital illustration.

15. The system of claim 12, wherein the digital illustration comprises a template generated at a first time, and the depiction of the person is inserted into the template at a second time later than the first time.

16. The system of claim 15, wherein the illustrative depiction of the person is dynamically generated when the digital illustration will be displayed to the user.

17. The system of claim 12, one or more processors may be further configured to modify the illustrative depiction of the person in the digital illustration to match a facial expression of the person with aspects of the digital image.

18. The system of claim 17, wherein the aspects of the digital image comprise one or more of mood, tone, or setting.

19. The system of claim 12, wherein the asset includes one or more text, logos, images, audio, or videos.

20. The method of claim 12, wherein the artificial intelligence model is trained using various images of persons, various images of scenes, and various artistic styles of comics to influence an output accurately depicting the person in the digital illustration.
